(19) United States
(12) Patent Application Publication
(10) Pub. No.: US 2007/0297620 A1
(43) Pub. Date: Dec. 27, 2007

(54) Methods and Systems for Producing a Zone of Reduced Background Noise

(76) Inventor: Daniel S. J. Choy, New York, NY (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/767,011

(22) Filed: Jun. 22, 2007

Related U.S. Application Data
(60) Provisional application No. 60/816,661, filed on Jun. 27, 2006.

(51) Int. Cl. H04R 3/02

(52) U.S. Cl. 381/73.1

(57) ABSTRACT

A system for facilitating conversational communications in an environment with background noise, the system including a microphone for sensing the background noise, a signal processor configured to process the microphone output and produce an anti-noise electrical output, and a directional speaker array configured to receive the anti-noise electrical output and directionally broadcast anti-noise audio output, the anti noise audio output destructively interfering with the environmental background noise.

### RELATED APPLICATIONS

The present application claims the priority under 35 U.S.C. §119(e) of previously-filed U.S. Provisional Patent Application No. 60/816,661, filed Jun. 27, 2006, entitled “Restaurant Silencer-Cone of Silence Process and Apparatus,” which is incorporated herein by reference in its entirety.

### BACKGROUND

In many environments where individuals desire to carry on a dialogue, there is a significant level of aural background noise which makes conversation in a normal tone almost impossible. For example, in many good restaurants, conversation among friends can be difficult because of the high level of background noise generated by the restaurant operations and other patrons. Background noise makes it particularly difficult for those who are hearing impaired to carry on conversations in normal tones.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1a and 1b show charts illustrating principles underlying sound cancellation techniques according to principles described herein.

FIG. 2 is a flow chart of an exemplary embodiment of the method of reducing audible background noise according to the principles described herein.

FIG. 3 is a cross-sectional diagram of a noise canceling apparatus according to principles described herein.

FIG. 4 is a diagram of an exemplary system for reducing background noise according to principles described herein.

FIG. 5 is a frontal view of a noise canceling apparatus according to the principles described herein.

FIG. 6 is a frontal view of a noise canceling apparatus according to the principles described herein.

FIG. 7 is an illustration showing the propagation of a noise waveform and corresponding anti-noise waveforms, according to the principles described herein.

FIG. 8 is a diagram of an exemplary system for reducing background noise according to principles described herein.

FIG. 9 is a diagram of an exemplary system for reducing background noise according to principles described herein.

FIG. 10 is a diagram of an exemplary system for reducing background noise according to principles described herein.

FIG. 11 is a flow chart of an exemplary embodiment of the method of reducing audible background noise according to the principles described herein.

FIG. 12 is a diagram of an exemplary system for reducing background noise according to principles described herein.

Throughout the drawings, identical reference numbers designate similar, but not necessarily identical, elements.

### DETAILED DESCRIPTION

Sound is a pressure wave typically in air which consists of a compression phase and a rarefaction phase. These pressure waves can be detected by the human ear or by microphones. Microphones convert these pressure waves into electrical signals, with the degree of compression or rarefaction translated into a corresponding signal amplitude.

As used herein, “waveform” refers to a compression wave traveling through a physical media. A “signal,” as combined with appropriate modifiers, represents a stream of electrical impulses generated by electronic components or transmitted between electronic components.

In the field of acoustics, background noise can be undesired sound that interfere with the perception of the desired sound. Examples of background noise are traffic noise, alarms, other people talking, wind or mechanical noise from devices such as refrigerators or air conditioning, power supplies or motors. In the case of a human conversation, background noise is any sound perceptible by the conversationalists that is not part of the voices of those engaging in a conversation. Such background noise interferes with the aural perception by the individuals of the dialogue in which they are engaged. There is a large and growing population of hearing impaired individuals who are particularly susceptible to interference from background noise. To compensate for undesirable background noise, conversationalists may be forced to increase the volume of their dialogue, move closer together, or leave the area.

The frequency the background noise is also important. Humans are capable of aurally sensing sound frequencies between approximately 20 Hz and 20,000 Hz. The frequencies in normal human conversation range from approximately 300 Hz to about 10,000 Hz, with the majority of the frequencies falling between 300 Hz and 3000 Hz. Background noise that contains frequencies within the range of human conversation particularly interferes with aural perception of dialog.

There are a variety of passive noise control methods such as insulation, sound absorbing tiles, or mufflers that absorb sound waves and thus dampen the ambient background noise. In many situations, the use of passive sound control is impractical, bulky, and expensive. Further, passive noise control methods are less effective in blocking the low-frequency noise components of background noise.

Another method of reducing background noise is through the use of active noise control. In active noise control, the background noise is sensed through a microphone which converts the sound wave to an electrical signal. The electrical signal is received by a signal processor and manipulated to produce an anti-noise electrical signal of the same amplitude and the opposite polarity of the original electrical signal. The anti-noise electrical signal is then conveyed to speakers which generate an anti-noise waveform. The background noise and the anti-noise waveform combine in a process called interference. Interference can be mathematically represented by taking the algebraic sum of the two waves. Destructive interference occurs when two waveforms combine to form a third waveform of lower amplitude than either of the original waveforms. If the amplitude of the anti-noise waveform is exactly equal to the background noise but of opposite polarity, the algebraic sum of the two waves will be zero. In theory, the anti-noise waveforms can destructively interfere with the background noise to completely nullify it. In practice, the interference between the background noise and the anti-noise waveform usually results in the third sound wave of significantly reduced amplitude which is less bothersome, for example, to those conducting a conversation.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

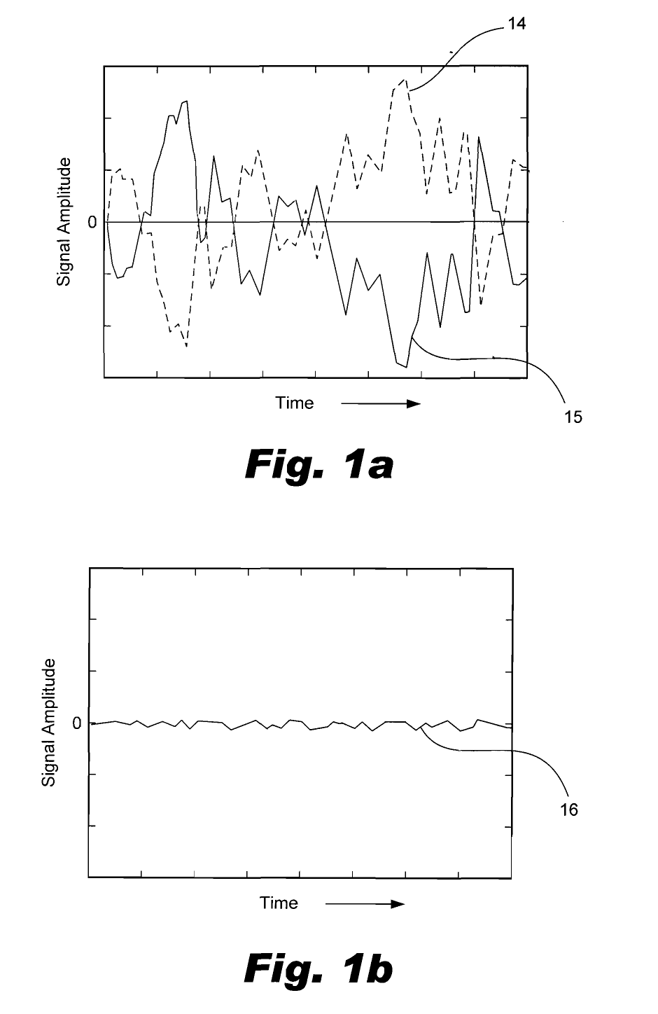

Referring now to FIG. 1, graphs are shown which illustrate the principles of active sound cancellation. In FIG. 1a, the solid line (15) represents the amplitude of broadband background noise as a function of time. The dashed line (14) represents an anti-noise wave form. The anti-noise waveform represented by dashed line (14) has substantially similar magnitude but opposite polarity as the background noise such that when the two waveforms are algebraically summed, through interference, the resulting waveform (16), shown in FIG. 1b, has significantly reduced amplitude. The resulting waveform (16) represents a reduction of the background noise level through active sound cancellation. The physical area in which the active sound cancellation produces reduced background noise levels is referred to herein as a zone of silence.

Time delays in generating and delivering the anti-noise waveform result in a difference in phase between the nose waveform and the anti-noise waveform. This results in less efficient destructive interference between the two waveforms. Thus the anti-noise waveform should arrive at the listener's ear at substantially the same time as the noise waveform for the best noise cancellation. For higher frequency noise signals, the background noise waveform varies more quickly and the timing the arrival of the anti-noise signal is more critical.

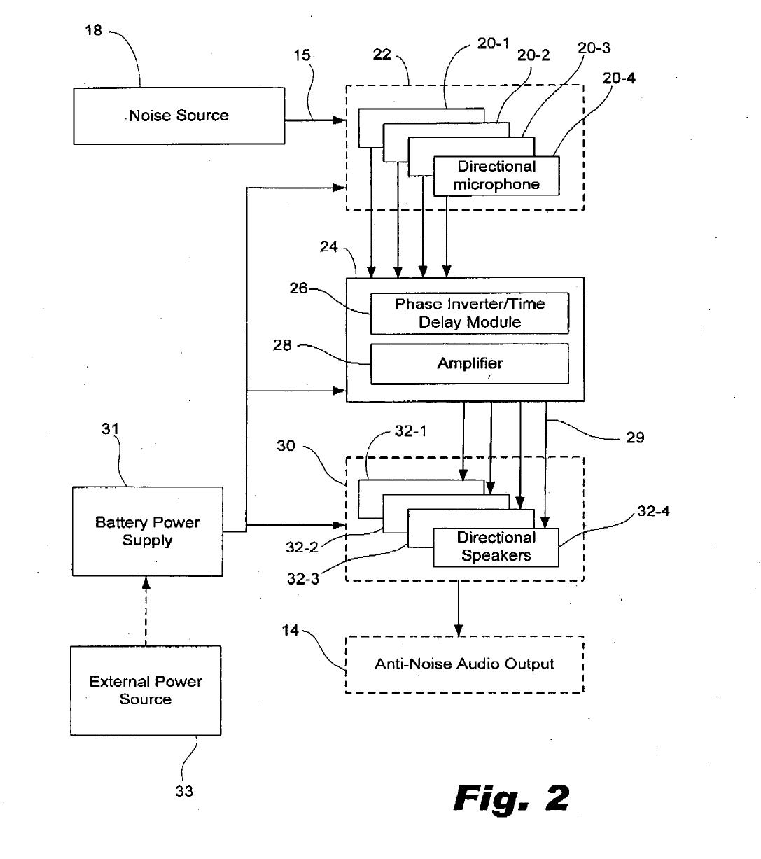

Referring now to FIG. 2, noise source (18) represents the source of background noise (15). The background noise (15) is sensed by microphone array (22). Generally, microphone array (22) consists of at least one microphone configured to sense aural waveforms. In this embodiment, microphone array (22) consists of a plurality of directional microphones (20, including 20-1 to 20-4). Directional microphones (20) convert the background noise into electrical signals. These electrical signals are conveyed to a noise signal processor (24). The basic functions of noise signal processor (24) are shown by two elements: a phase inverter/time delay module (26) and an amplifier (28).

The phase inverter/time delay module (26) manipulates the electrical signals it receives to produce a corresponding signal with opposite polarity. The amplifier (28) is configured to adjust the amplitude of the output of the phase inverter/time delay module (26). The phase inverter/time delay module (26) and amplifier (28) operate together to produce an anti-noise electrical output. Those of skill in the art of signal processing will understand that the phase inverter/time delay module (26) and amplifier (28) are only intended to represent the function of the signal processor and that signal processors may be constructed with a variety of different components and configurations.

The anti-noise electrical output is conveyed to directional speaker array (30). Generally, speaker array (30) consists of at least one speaker configured to receive electrical signals and convert the electrical signals into aural waveforms. In this embodiment, speaker array (30) is comprised of a plurality of directional speakers (32, including 32-1 to 32-4). The directional speakers convert the anti-noise electrical output into the anti-noise audio output (14). The anti-noise audio output (14) interferes with the background noise (15) generated by noise source (18). The power required by the process described in FIG. 2 can be supplied by, for example, battery power supply (31) or alternatively by an alternating current power source (33).

Those of skill in the art of signal processing will understand that a variety of components and configurations could be used to create the appropriate anti-noise audio output. For example, analog-to-digital converters may be used to convert the electrical signals from analog form into digital form for manipulation of the electrical signal within digital signal processors. Similarly, digital-to-analog converts can be utilized to convert digital signals into analog outputs directed to the speakers.

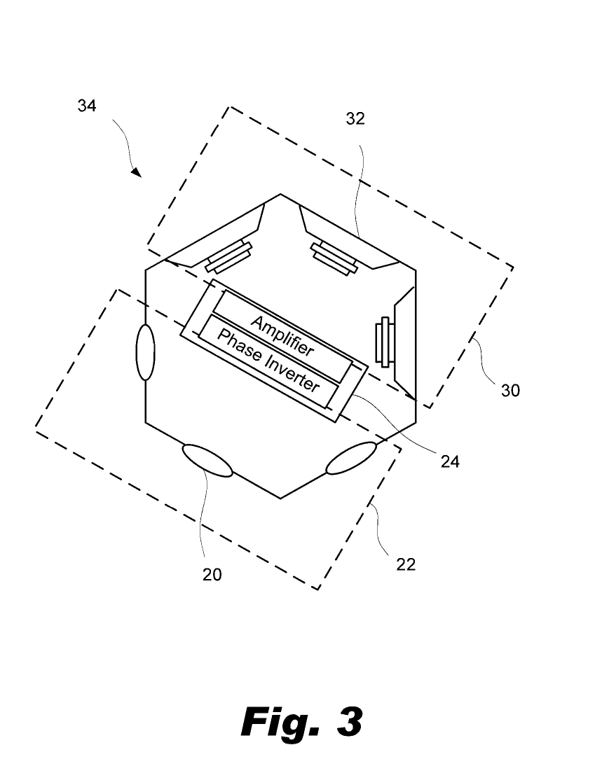

Now referring to FIG. 3, an exemplary noise cancellation system (34) is illustrated. In FIG. 3, a microphone array (22) consists of a plurality of directional microphones (20) angularly disposed around a portion of the perimeter of noise cancellation system (34). A corresponding array of speakers (32) is also angularly arranged around the perimeter of the system (34). In FIG. 3, the array of microphones (22) and the array of speakers (32) are illustrated as being on opposite sides of the system (34). However, as will be appreciated by those skilled in the art, the array of microphones (20) may surround the perimeter of the system (34) and, accordingly, the array of speakers (32) may also surround the perimeter of the system (34).

Signal processor (24) is interposed between microphone array (22) and the speaker array (30), and configured to receive electrical signals from the microphones (20). The noise signal processor (24) manipulates the received electrical signals, generates anti-noise electrical output, and transmits the anti-noise electrical output (29) to the speaker array (18). The speaker array (18) converts the anti-noise electrical output (29, FIG. 2) into anti-noise audio output (14). As a result of the plurality of directional microphones (20) interposed around the perimeter of noise cancellation system (34), background noise emanating from a variety of angularly distinct sources can be cancelled by directing the appropriate anti-noise electrical output (29, FIG. 2) to the corresponding directional speaker (32). For example, the corresponding directional speaker (32) is the speaker or speakers opposite a particular directional microphone (20) in the direction of linear sound propagation.

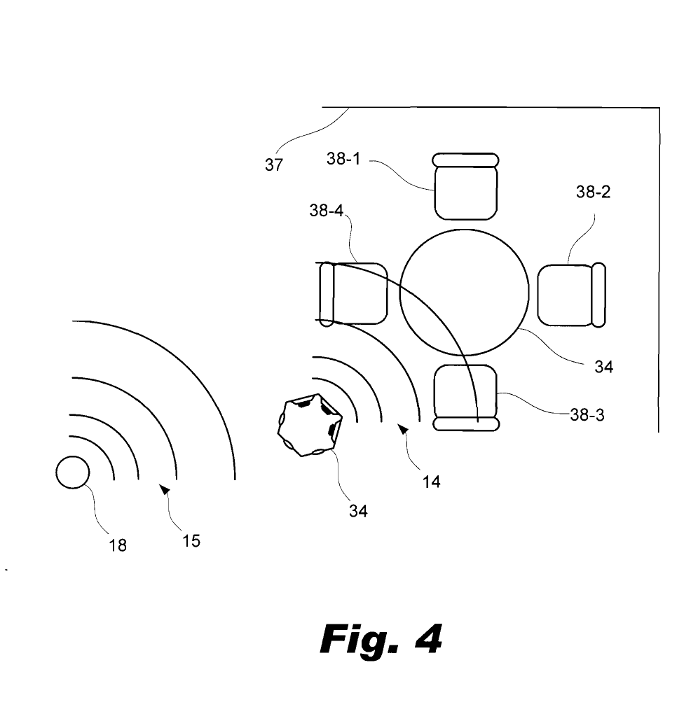

FIG. 4 illustrates an exemplary system of sound cancellation using noise cancellation system (34) to facilitate dialog in an environment where background noise (15) is being generated by noise source (18). The noise cancellation system (34) is interposed between noise source (18) and the conversationalists (38) seated in chairs surrounding a table (35). Sound barrier (37) bounds the conversational area on two sides. The noise cancellation system (34) is oriented so that the directional microphone array (22) is directed toward noise source (18). The background noise (15), as would be evident to those skilled in the audio arts, does not typically emanate from a point source, however, this simplified presentation of noise source (18) is believed to be adequate for illustrating the principles described. The background noise (15) is sensed by microphone array (22). The resulting electrical audio signal is manipulated by noise signal processor (24) and output from speaker array (30) as the anti-noise audio output (14). The anti-noise audio output (14) is configured to destructively interfere with the background noise (15) creating a zone of silence within which the conversationalists can carry on a dialogue with reduced levels of background noise (15).

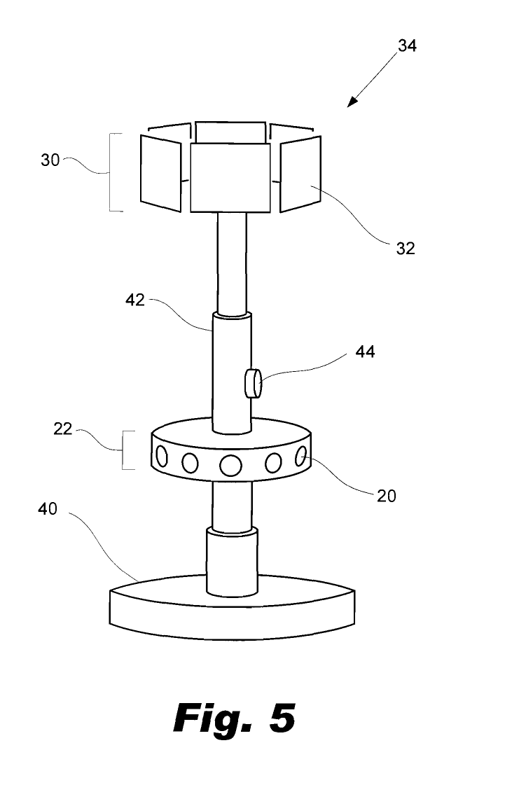

FIG. 5 illustrates an exemplary embodiment of noise cancellation system (34). In this embodiment, the base (40) is configured to be placed on flat horizontal surface, such as a table or floor. Telescoping mast (42) is attached to base (40) and supports microphone array (22). The telescoping mast (42) allows the noise cancellation system (34) to be collapsed, reducing its size and making it more portable. Microphone array (22) consists of a plurality of microphones (20) angularly positioned to sense background noise through 360°. Speaker array (30) is attached to the upper portion of telescoping mast (42). In this embodiment, speaker array (30) consists of a plurality of directional speakers angularly positioned to generate anti-noise waveforms through 360°. Control knob (44) is attached to telescoping mast (42). Control knob (44) allows the user to adjust the amplitude of the anti-noise electrical output directed to the speaker array (30) thus allowing the user to adjust the output volume of the anti-noise audio output generated by speaker array (30).

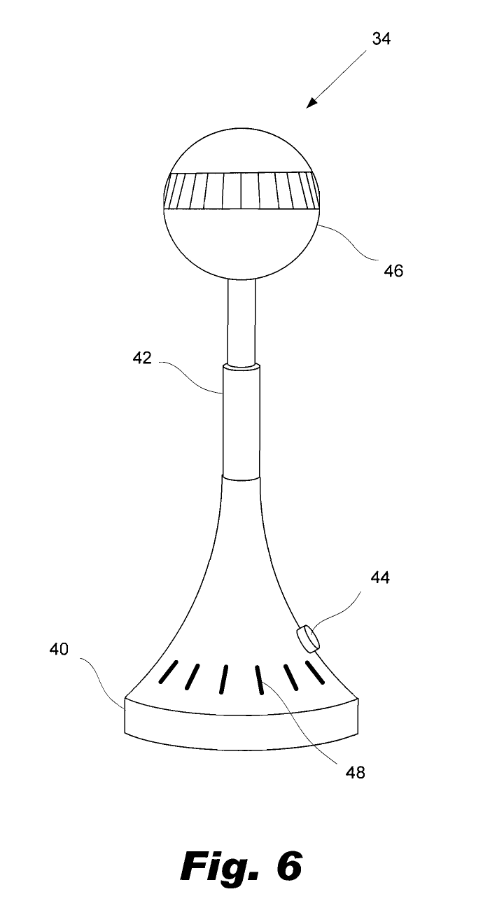

FIG. 6 illustrates another exemplary embodiment of noise cancellation system (34). The noise cancellation system (34) shown in FIG. 6 comprises a base (40) with a number of sound receptacles (48) interposed around the surface of the base (40). Within the base (40), but not shown, is a microphone. Also connected to the base is control knob (44). Control knob (44) allows the user to vary the amplitude of the anti-noise audio output. The telescoping mast (44) is attached to base (40), and allows the unit to be collapsed, reducing its size and making it more portable. Omni-directional speaker (46) is attached to the top of mast (42). Omni-directional speaker (46) broadcasts anti-noise audio waveforms through 360°.

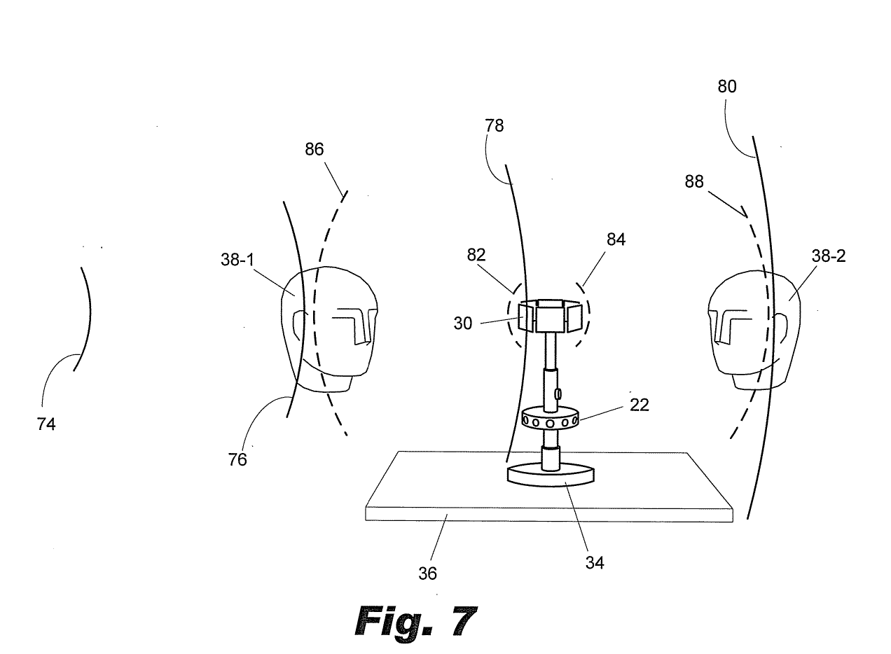

Now referring to FIG. 7, which shows a diagram of the propagation of a noise waveform and its corresponding anti-noise waveform through an open air space. A first conversationalist (38-1) and a second conversationalist (38-2) are sitting on either side of a table (36). The noise cancellation system (34) is supported by the table (36) in a position that is in between the two conversationalists. A first solid curved line (74) represents the noise waveform at time “T −,0.0025” seconds. The noise waveform propagates from the left to the right across the page. Successive solid lines represent the location of the noise waveform at distinct times. A second solid line (76) represents the same noise waveform at time “T+0.0000” seconds. At time “T+0000” seconds, the noise waveform has reached the ear of the first conversationalist (38-1). A third solid line (78) represents the noise waveform at time “T+0.0025” seconds. At time “T+0.0025” seconds, the noise waveform reaches the sound cancellation system (34) and is sensed by a microphone (22). At time “T+0.0050” seconds, the noise waveform has reached the ear of the second conversationalist (38-2) as represented by a fourth solid line (80).

The sound cancellation system (34) senses the noise waveform and generates an anti-noise waveform. A first dashed line (82) represents the anti-noise waveform at time “T+0.0025+P” where P equals the processing time required to capture the noise waveform, manipulate it to produce the anti-noise waveform, and deliver the anti-noise waveform to the speaker facing the first conversationalist (38-1). Similarly, a second dashed line (84) represents the anti-noise waveform radiating from the speaker facing the second conversationalist (38-2) at time “T+0.0025+P”. As previously described, the anti-noise waveform (82) and the opposing anti-noise waveform (84) could have a different composition and separate directional characteristics. A third dashed line (86) represents the anti-noise waveform at time “T+0.0050+P.” Thus, the anti-noise waveform represented by the third dashed line (86) arrives at the ear of the first conversationalist (38-1) “P+0.005” seconds after the noise waveform (76) has passed. The anti-noise noise waveform (88) arrives at the ear of the second conversationalist (38-2) “P” seconds after the noise waveform (80) has passed. These time errors represent a phase delay of the anti-noise waveform with respect to the noise waveform. The smaller these time errors are, the greater effectiveness the system has in canceling noise waveforms.

There are several ways to minimize the time errors. First, the processing time could be minimized. Second, the noise wave form can be sensed as early as possible. By way of example and not limitation, a method for sensing a sound waveform more quickly includes moving the microphones closer the source of the noise by placing the microphone on an extendable arm. Another method for early sensing of noise waveforms could use optical means to sense the noise waveform. By way of example and not limitation, a laser or other light source could reflect off items that are vibrating in response to ambient noise waveforms. The reflected light would then be sensed by an optical receiver. Because light travels through most mediums much faster than sound, the noise waveform could be sensed by the noise cancellation system prior to the noise waveform reaching the conversationalists. Another technique for reducing the time error might include moving the microphones closer to the noise source. For example, wireless microphones could be worn by the conversationalist or placed at the perimeter of the conversation area. These wireless microphones could sense the noise waveforms and transmit the noise signal to the noise cancellation system using electromagnetic means. All of these techniques have the potential to minimize the time errors in delivering anti-noise waveforms to the conversationalist.

Thus, the principles of active noise cancellation may be applied in portable systems such as those described above. These portable systems can be configured to be transported to restaurants, meeting places, noisy apartments, or offices. In addition, those who control the meeting places may choose to install fixed systems for noise cancellation. For example, airports and restaurants may install fixed noise cancellations systems that are configured to reduce unwanted background noise in certain areas but would not attenuate desired audio communication, such as announcements or music. Similarly, noise cancellation systems may gather, manipulate, amplify, and rebroadcast the voices of the conversationalists as an additional method to reduce the negative effects of background noise.

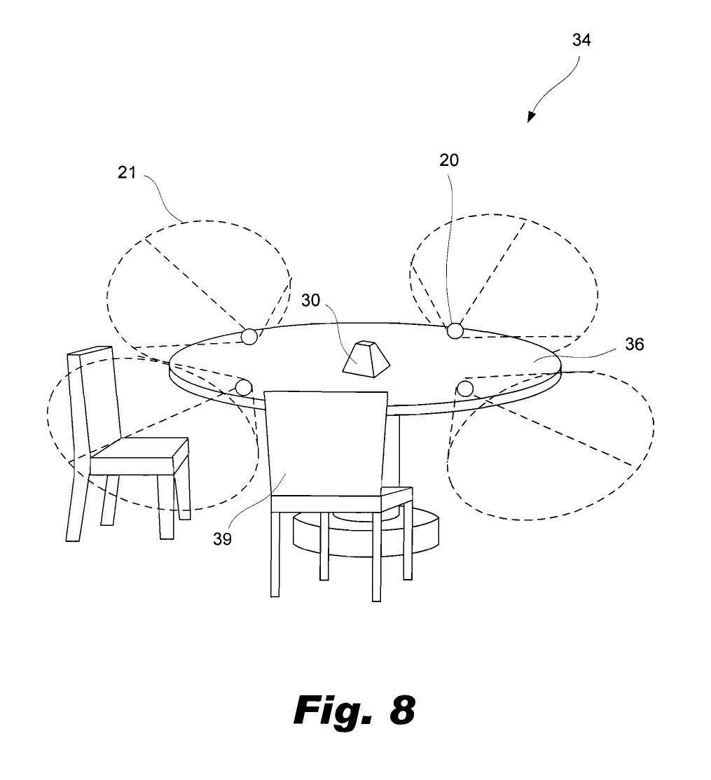

In FIG. 8, an exemplary system for facilitating conversation in an environment with background noise is shown. As illustrated in FIG. 8, the exemplary system includes noise canceling system (34) with speaker array (30) located on a table (35). A microphone array (22) is angularly disposed around a portion of the perimeter of the table (35) such that microphones (20) are positioned between the chairs (39) occupied by the conversationalists. The locations of the individual directional microphones (20) at the perimeter of table (36) between chairs (39) directs the microphone sensing area (21) primarily toward background noise sources beyond the conversational area as opposed to the voices of the conversationalists.

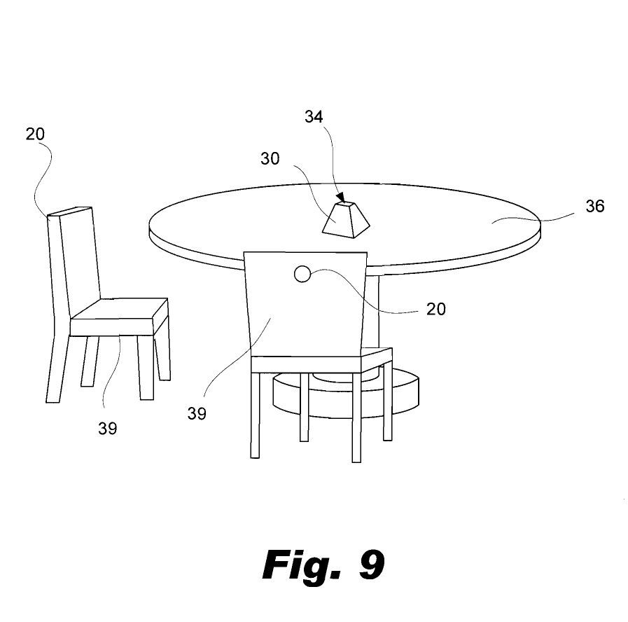

Now referring to FIG. 9, an exemplary system is shown for facilitating conversation in an environment containing background noise. In FIG. 9, the microphone array (22, FIG. 2) is placed on the backs of the chairs (39). In the illustrated example, each chair (39) supports one microphone (48) of the microphone array. The advantages of this microphone configuration include sensing background noise before the background noise reaches the ears of the conversationalist. It has the further advantage that, in the event the chair (39) that the conversationalist is sitting in is moved to a different location around the table (35), the microphone (20) moves with the conversationalist and continues to sense background noise proximate to, or coming from behind, the conversationalist. Additionally, microphone (20) is further isolated from the verbal dialogue between the conversationalists and more clearly picks up relevant background noise.

In an alternative embodiment, the microphone (20) could be attached to other objects in the vicinity of the conversationalist, such as walls, ceiling, planters, partitions, or decorative columns. These microphones transmit the noise signal to the noise canceling system via wire or wireless means. By way of example and not limitation, these microphones could be placed at the entrance to party rooms where loud sounds inside could be canceled outside. Or they could be placed outside food staging areas to reduce the necessary but annoying noise from food service activities. Hotels, restaurants, and casinos could strategically place sound cancellation systems and microphones to create quiet zones within a large space such as sports bar without changing the fundamental character of the facility. Offices, apartments, and hotels could use a noise canceling system to reduce the noise waveforms such as fans, elevators, or traffic passing outside.

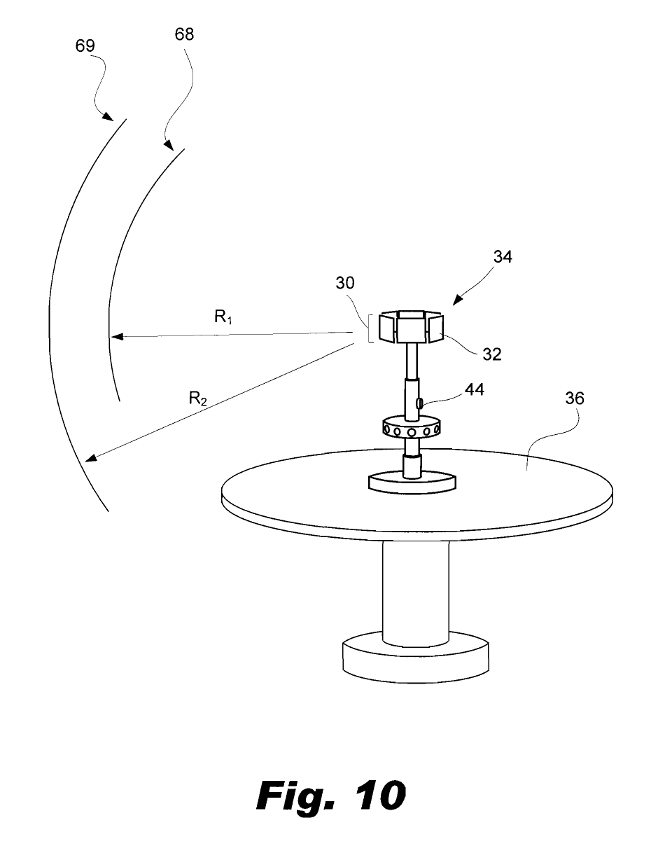

FIG. 10 illustrates additional aspects of embodiments of the present invention having a control knob (44). Control knob (44) is configured to change the amplitude of the anti-noise waveforms generated by the speaker array (30). Before the control knob (44) is manually adjusted, the anti-noise waveform creates a zone of silence (68) with an effective radius of R1. By adjusting knob (44) to increase the amplitude of the anti-noise waveforms generated by speaker array (30), the effective zone of silence (68) is extended to create an enlarged zone of silence (69) having a radius of R2. Thus, by adjusting the knob (44) the user can alter the amplitude of the anti-noise output to create a zone of reduced background noise of the desired radius.

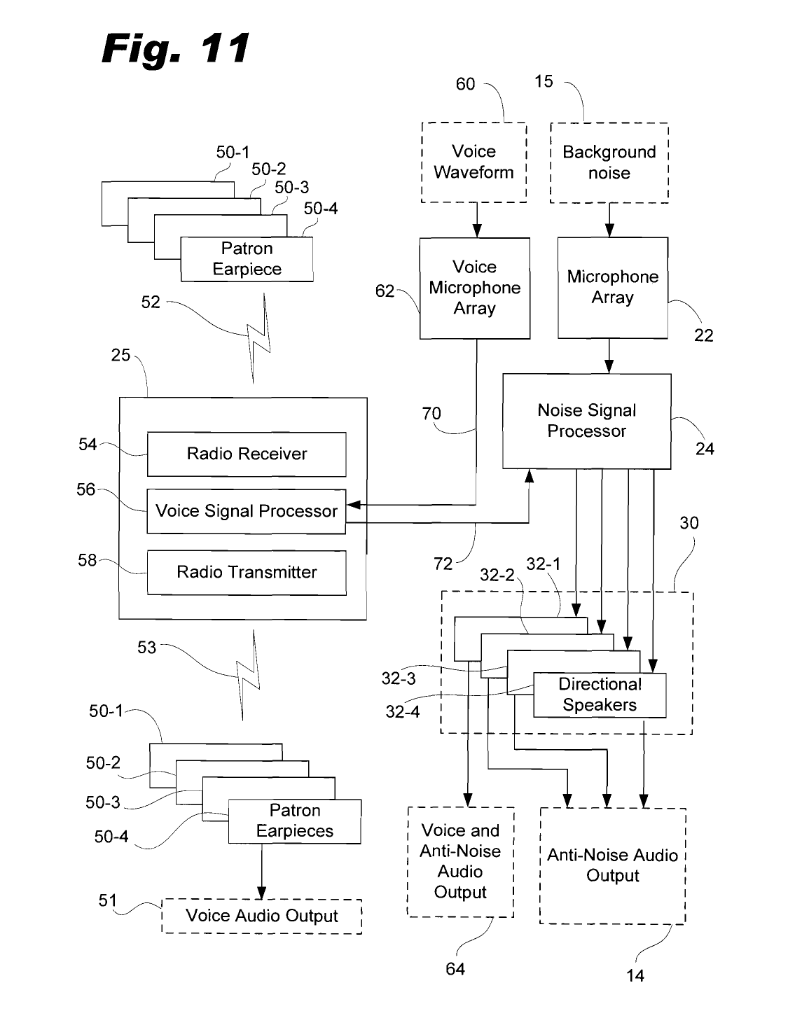

Referring now to FIG. 11, an exemplary system for background noise cancellation includes, in addition to previously introduced elements, voice microphone array (62) and a central wireless router (25), also referred to as a calamari stalk, that wirelessly communicates with a number of patron earpieces (50, including 50-1 to 50-4). Previously described elements include background noise (15) detected by the microphone array (22), the output of the microphone array (22) being manipulated by the noise signal processor (24) and the output of noise signal processor (24) being converted by a speaker array (30) into anti-noise waveforms (14).

Patron earpieces (50) each include a microphone and are configured to detect the corresponding patron's voice with the earpiece microphone and transmit the output of that microphone as a wireless voice transmission (52) to the wireless router (25) or calamari stalk. The earpieces are also configured to receive wireless voice transmissions (53) from the wireless router (25) and generate aural waveforms audible to the earpiece wearer. Exemplary embodiments of the patron's earpiece (50) include the Bluetooth compatible wireless mobile earpieces. Commercially available earpieces include those made by SoundID, Inc., such as their PSS and SM 100 models.

The wireless router (25) comprises a radio receiver (54) configured to receive wireless transmissions from the patron earpieces (50), a voice signal processor (56), and a radio transmitter (58) configured to broadcast wireless transmissions to patron earpieces (50). In the exemplary embodiment shown in FIG. 11, the patron earpieces (50) sense the voice of patrons involved in dialogue and transmit a corresponding wireless voice transmission (52) to radio receiver (54). Radio receiver (54) conveys the voice transmission to voice signal processor (56).

Additionally, the voice microphone array (62) comprises at least one microphone configured to detect the voices of conversationalists and generate a microphone voice signal (70). The voices of patrons without earpieces are detected by the voice microphone array (62) which conveys this data as microphone voice signal (70) to voice signal processor (56). Voice signal processor (56) manipulates voice data received from patron earpieces (50) and from the voice microphone array (62) to create a combined voice signal (72). The voice signal processor (56) manipulation may involve filtering, amplifying, and combining various voice transmissions so that the audible dialogue may be more clearly heard when converted to aural waveforms. The voice signal processor (56) then conveys the combined voice signal (72) to the radio transmitter (58) which sends wireless or rebroadcast signal (53) to the patron earpieces (50). Patron earpieces (50) convert the wireless or rebroadcast signal (53) into voice audio output (51) which is heard by the patrons through their earpieces (50)

Additionally, voice signal processor (56) conveys combined voice signal (71) to noise signal processor (24) for amplification and distribution to appropriate directional speakers (32). As in previous embodiments directional speakers (32) produce anti-noise audio output (14), and also transmit voice and anti-noise audio output (64) for the benefit of any patrons without an earpiece (50).

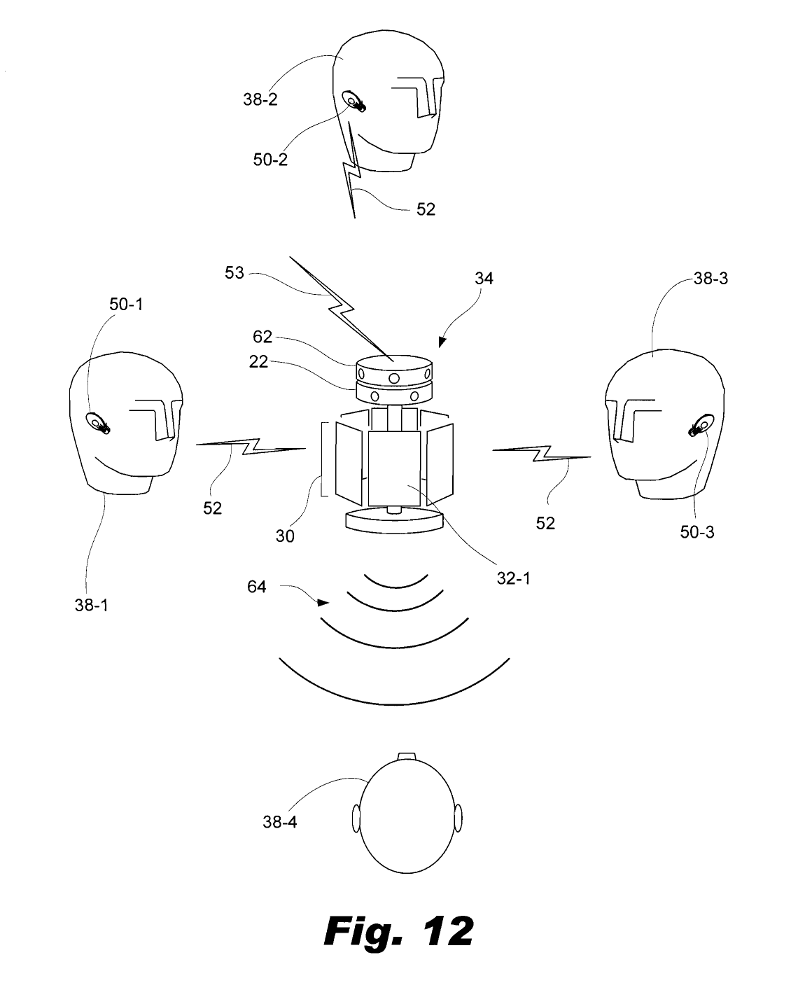

Now referring to FIG. 12, an exemplary system for facilitating verbal dialogue between conversationalists comprising a noise cancellation system (34), a plurality of conversationalists (38), and earpieces (50). In this embodiment, the noise cancellation system (34) consists of a speaker array (30), a microphone array (22), and a voice microphone array (62). The noise cancellation system (34) is further configured to receive wireless voice transmission (52), transmit wireless rebroadcast (53), and other signal processing tasks as described in FIG. 11. In this embodiment, the conversationalists (38, including 38-1 to 38-3) are equipped with earpieces (50-1, 50-2, and 50-3, respectively). These earpieces (50) may consist of off-the-shelf or custom-made devices that are capable of converting the patron's voice into an electrical signal and conveying that electrical signal as a wireless voice transmission (52) to noise cancellation unit (34). Additionally, the earpieces may have the capability of receiving wireless broadcast (53) from noise cancellation system (34) and converting wireless broadcast (53) into audible waveforms detectable by patrons (38).

As in previous embodiments, microphone array (22) detects background noise which is then processed and distributed to directional speaker array (30) by noise canceling system (34). The anti-noise audio output may also be included in the wireless rebroadcast (53).

In the embodiment shown in FIG. 12, patron (38-4) does not have an earpiece. His or her voice is picked up by voice microphone array (62) and processed by noise cancellation system (34) and included in the voice and anti-noise audio output (64). In an alternative embodiment, the patron (38-4) could wear a separate wireless microphone that is adapted to sense the voice of the wearer. The voice of the patron (38-4) may also be included in the wireless rebroadcast (53) from noise canceling system (34) to the patron earpieces (50).

Other embodiments of the invention could involve an earpiece picking up ambient noise at the patron's ear and transmitting that noise to other earpieces or to a central processor. The other earpiece(s) or central processor recognize this signal as noise to be cancelled and with appropriate adjustments in timing determined by the distance from the central processor or other earpieces to the transmitting earpiece, invert the noise polarity and radiate an anti-noise waveform. The timing determination can be made by periodically sending a special signal to the other earpieces and measuring the time to return.

Further, the earpieces alone could create a network capable of facilitating dialog in environments with high levels of background noise. In this mesh network scheme, the earpieces relay the noise and/or voice signals to the other earpieces, process the received data and generate the appropriate waveforms.

In all of the previously described embodiments of the invention, the specific parameters of the noise cancellation system may be tailored to the specific environment, the listener's hearing loss curve, or other parameters.

The preceding description has been presented only to illustrate and describe embodiments and examples of the principles described. This description is not intended to be exhaustive or to limit these principles to any precise form disclosed. Many modifications and variations are possible in light of the above teaching.

1. A system for producing a zone of reduced background noise, said system comprising:
at least one microphone for sensing background noise, said at least one microphone generating a signal as a function of said background noise;
a background noise processor configured to process said signal to create an anti-noise waveform configured to reduce an amplitude of said background noise in said zone, and
at least one speaker configured to directionally broadcast said anti-noise waveforms as anti-noise audio output into said zone, wherein said anti-noise audio output destructively interferes with said background noise.

2. The system of claim 1, wherein:
said at least one microphone comprises a plurality of microphones angularly disposed said plurality of microphones generating a plurality of signals as a function of said background noise; and
said at least one speaker comprises a plurality of speakers directed at different angles with respect to said zone;
wherein said background noise processor is configured to process said plurality of signals to create corresponding, direction-specific anti-noise waveforms, and said plurality of speakers is configured to directionally broadcast said direction-specific anti-noise waveforms as anti-noise audio output for destructively interfering with said background noise.

3. The system of claim 2, wherein said background noise processor comprises an amplifier and at least a phase shift circuit for phase shifting or a polarity inverter.

4. The system of claim 2, additionally comprising a user control that controls an amplitude of said anti-noise audio output.

5. The system of claim 2, wherein said plurality of microphones comprises a directional microphone array configured to distinguish an angular direction associated with received background noise.

6. The system of claim 2, wherein at least portion of said microphones use optical means to sense background noise.

7. The system of claim 2, farther comprising:
a second plurality of microphones configured to sense speech within said zone and generate a second plurality of electronic signals as a function of said speech; and
a voice signal processor configured to process said second plurality of signals, and output a speech signal;
wherein said plurality of speakers is configured to output said speech signal so as to make said speech more audible to one or more listeners over said background noise.

8. The apparatus of claim 7, wherein at least a portion of said plurality of said second plurality of microphones are contained within earpieces configured to be worn by said one or more listeners.

9. The apparatus of claim 7, wherein at least a portion of said plurality of speakers are contained within earpieces configured to be worn by said one or more listeners.

10. The apparatus of claim 9, wherein said earpieces additionally contain said background noise processor, said first plurality of microphones, said second plurality of microphones, said plurality of speakers, and said voice signal processor; each of said earpieces being configured to transmit said background noise and said speech to other of said earpieces, each of said earpieces being configured to receive said background noise and said speech from other of said earpieces.

11. A portable apparatus for producing a zone of reduced background noise, said apparatus comprising:
a base,
a telescoping mast having a first and a second end, said first end attached to said base;
a microphone configured to sense background noise and convert said background noise into a signal;
a background noise processor configured to process said signal and generate a corresponding anti-noise signal;
at least one speaker attached to said second end of said mast; said at least one speaker configured to broadcast said anti-noise signal as an anti-noise audio waveform; said anti-noise audio waveform broadcast destructively interfering said background noise, thereby creating said zone within which speech can be more clearly heard.

12. The apparatus of claim 11, further comprising a control configured to adjust an amplitude of said anti-noise waveform.

13. The apparatus of claim 11, wherein said microphone comprises a directional microphone array that additionally senses voice sources and said background noise processor is configured to distinguish between said voice sources and said background noise when producing said anti-noise waveform.

14. The apparatus of claim 13, wherein said directional microphone array is comprised of individual microphones located on the backs of chairs.

15. The apparatus of claim 11, wherein said at least one speaker comprises an array of speakers configured to generate omni-directional anti-noise output.

16. The apparatus of claim 11, further comprising:
a plurality of earpieces each having a microphone configured to convert a user's voice into an electrical signal and a wireless transmitter configured to transmit said electrical signal as a wireless signal;
a receiver configured to receive said wireless signal;
a voice signal processor configured to process the received signal and generate a processed signal;
a radio transmitter configured to rebroadcast said processed signal, wherein each said earpiece is configured to receive said processed signal and convert said processed signal into audio output.

17. The apparatus of claim 16, further comprising a least one additional microphone configured to receive voice input from a user not wearing an earpiece, said voice input being converted into an electrical signal and transmitted to said voice signal processor.

18. The apparatus of claim 16, wherein said earpieces each comprise a wireless receiver for receiving said anti-noise signal and a speaker for outputting said anti-noise waveform.

19. A method for producing a zone of reduced background noise comprising:
sensing said background noise using an array of directional microphones, each directional microphone creating a signal representing said background noise,
sending each of said signals to a central background noise processor, said background noise processor creating a plurality of anti-noise waveforms as a function of said signals, and
directing each of the plurality of anti-noise waveforms to a plurality of directional speakers, said plurality of directional speakers directionally broadcasting said anti-noise waveforms as audio anti-noise output, said audible anti-noise output destructively interfering with a portion of said audible background noise to reduce background noise in said zone.

20. The method of claim 19, further comprising varying an amplitude of the audio anti-noise output to optimize destructive interference of the background noise in the zone.
